(19) United States
(12) Patent Application Publication
(10) Pub. No.: US 2015/0140363 A1
(43) Pub. Date: May 21, 2015

(54) BATTERY PACK

(71) Applicant: Samsung SDI Co., Ltd., Yongin-si (KR)

(72) Inventors: Sang-Joo Lee, Yongin-si (KR); Hyung-Sin Kim, Yongin-si (KR)

(21) Appl. No.: 14/540,956

(22) Filed: Nov. 13, 2014

(30) Foreign Application Priority Data
Nov. 21, 2013 (KR) 10-2013-0142039

(51) Int. Cl. H01M 2/34; H01M 2/26

(52) U.S. Cl. CPC H01M 2/34; H01M 2/26; H01M 2200/00; H01M 2220/30
USPC 429/7

(57) ABSTRACT

A battery pack includes a plurality of bare cells, a protection device on the plurality of bare cells, a connecting tab configured to electrically couple the bare cells to the protection device, and a protective circuit module positioned on the bare cells. The protective circuit module has a plurality of openings at positions where the connecting tab is coupled with the bare cells and/or the protection device.

### CROSS-REFERENCE TO RELATED APPLICATION

This application claims priority to and the benefit of Korean Patent Application No. 10-2013-0142039, filed on Nov. 21, 2013 in the Korean Intellectual Property Office, the disclosure of which is incorporated herein in its entirety by reference.

### BACKGROUND

1. Field

An aspect of the present invention relates to a battery pack.

2. Description of the Related Art

Recently, secondary batteries have been variously used as power sources of portable electronic devices. As the portable electronic devices are used in various fields, demands for secondary batteries are being rapidly increased. The secondary batteries are designed to be charged/discharged a plurality of times, and accordingly are economically and environmentally efficient. Thus, the use of the secondary batteries is encouraged and increasing.

As small size and light weight electronic devices are required, small size and light weight secondary batteries are also required. However, because a material, such as lithium, having high reactivity is provided at the inside of the secondary battery, the size and weight of the secondary battery is limited to ensure the safety of the secondary battery. Accordingly, a variety of studies have been conducted to develop a battery pack which can be small in size and light in weight while improving the safety of a secondary battery.

### SUMMARY

Aspects of embodiments of the present invention are directed toward a battery pack which can be small in size and light in weight by employing a new structure.

Aspects of embodiments of the present invention are also directed toward a battery pack having a protection element, thereby improving the safety of the battery pack.

According to an embodiment of the present invention, a battery pack includes: a plurality of bare cells; a protection device on the plurality of bare cells; a connecting tab configured to electrically couple the bare cells to the protection device; and a protective circuit module positioned on the bare cells, wherein the protective circuit module has a plurality of openings at positions where the connecting tab is coupled to the bare cells and/or the protection device.

The connecting tab may include a first connecting portion coupled to a first bare cell from among the bare cells; a second connecting portion coupled to a second bare cell from among the bare cells; and a third connecting portion coupled to the protection device.

The plurality of openings may include a first opening at an area of the protective circuit module, corresponding to the position at which the first connecting portion and the first bare cell are coupled; a second opening at an area of the protective circuit module, corresponding to the position at which the second connecting portion and the second bare cell are coupled; and a third opening at an area of the protective circuit module, corresponding to the position at which the third connecting portion and the protection device are coupled.

The first connecting portion may be electrically coupled to a first electrode terminal of the first bare cell. The second connecting portion may be electrically coupled to a second electrode terminal of the second bare cell. The third connecting portion may be electrically coupled to a first lead portion of a plurality of lead portions of the protection device.

The first connecting portion may overlap with a top surface of the first electrode. The second connecting portion may overlap with a top surface of the second electrode terminal. The third connecting portion may overlap with a top surface of the first lead portion.

The openings may be respectively located in the protective circuit module at positions corresponding to the first, second, and third connecting portions.

A second lead portion of the plurality of lead portions of the protection device may be electrically coupled to the protective circuit module.

The connecting tab may further include a main body portion coupled to the first, second, and third connecting portions. The first, second, and third connecting portions may be extended from the main body portion.

A first distance from the protective circuit module to the first, second, or third connecting portion may be different from a second distance from the protective circuit module to the main body portion.

The first distance may be greater than the second distance.

The connecting tab may further include a step between at least one of the main body portion and the first connecting portion, the main body portion and the second connecting portion, or the main body portion and the third connecting portion.

The main body portion and the protective circuit module may be coupled to each other.

The main body portion and the protective circuit module may be coupled to each other through soldering.

The coupling between the connecting tab and the bare cells, and/or the coupling between the connecting tab and the protection device may be performed through the openings.

The coupling between the connecting tab and the bare cells, and/or the coupling between the connecting tab and the protection device may be performed through the openings, using welding.

The battery pack may further include a holder positioned between the protective circuit module and the plurality of bare cells.

The protection device and the connecting tab may be positioned inside an opening in the holder.

The plurality of bare cells may be coupled in parallel to each other.

The battery pack may further include an insulation member between the protection device and the plurality of bare cells.

Other features and aspects of the present invention will become more fully apparent from the following detailed description, taken in conjunction with the accompanying drawings.

Terms or words used in this specification and claims should not only be restrictively interpreted according to their ordinary meanings or dictionary-based meanings, but should also be interpreted conforming to the scope of the present invention on the basis of the principle that an inventor can properly define the concept of a term to describe and explain his or her invention in the best ways.

According to an embodiment of the present invention, in the battery pack, the protection element is coupled to (e.g., connected to) a plurality of bare cells through the connecting tab, so that it is possible to reduce or minimize the size and weight of the battery pack and to improve the safety of the battery pack.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the figures, dimensions may be exaggerated for clarity of illustration. It will be understood that when an element is referred to as being “between” two elements, it may be the only element between the two elements, or one or more intervening elements may also be present. Like reference numerals refer to like elements throughout.

FIG. 1 is a perspective view of a battery pack according to an embodiment of the present invention.

FIG. 2 is a perspective view of the battery pack shown in FIG. 1, in which a protective circuit module is not illustrated.

FIG. 3 is an exploded perspective view of the battery pack shown in FIG. 1, in which the protective circuit module is not illustrated.

FIG. 4 is a sectional view taken along the line A-A′ of the battery pack shown in FIG. 1.

FIG. 5 is an exploded perspective view of the battery pack shown in FIG. 1.

FIG. 6 is a perspective view of a battery pack according to another embodiment of the present invention.

FIG. 7 is a perspective view of the battery pack shown in FIG. 6, in which a protective circuit module is not illustrated.

### DETAILED DESCRIPTION

In the following detailed description, only certain example embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it may be directly on the another element or be indirectly on the another element with one or more intervening elements interposed therebetween. Also, when an element is referred to as being “connected to” another element, it may be directly connected to the another element or be indirectly connected to the another element with one or more intervening elements interposed therebetween. Hereinafter, like reference numerals refer to like elements. Further, the use of “may” when describing embodiments of the present invention refers to “one or more embodiments of the present invention.”

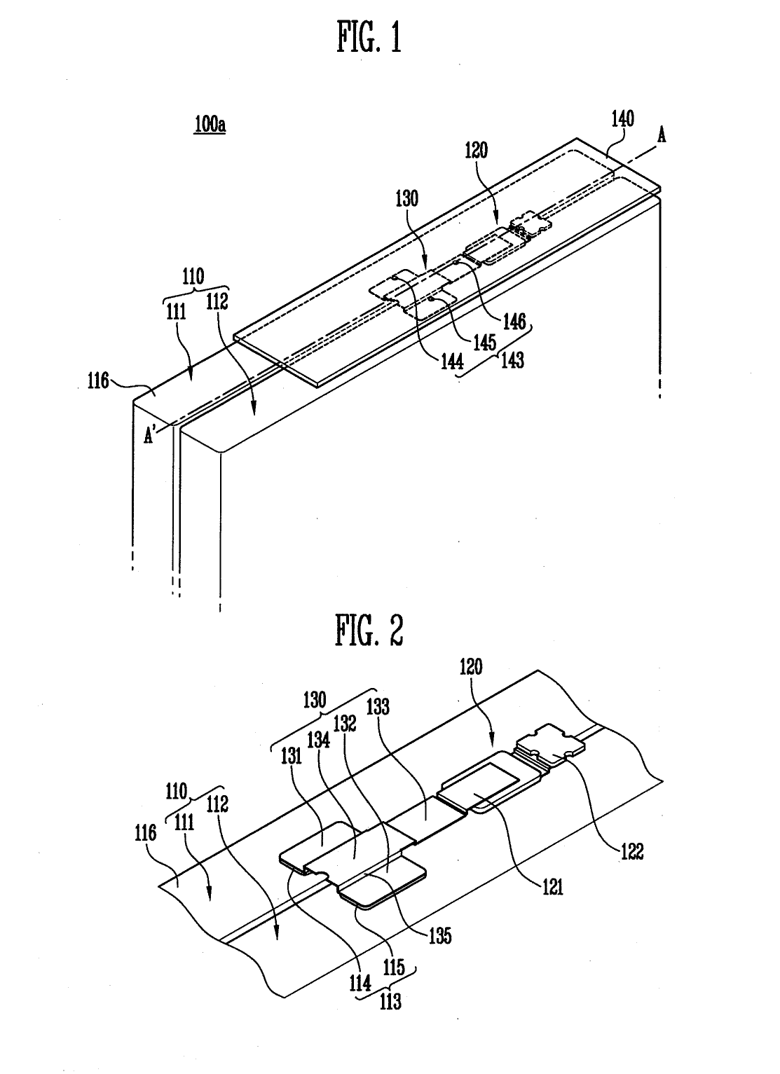

FIG. 1 is a perspective view of a battery pack 100a according to an embodiment of the present invention. Hereinafter, the battery pack 100a according to this embodiment will be described with reference to FIGS. 1 to 5.

As shown in FIG. 1, the battery pack 100a according to this embodiment includes a plurality of bare cells 110, a protection element 120 (e.g., a protection device) positioned on one surface 116 of the bare cells 110, a connecting tab 130 located between adjacent bare cells 100 and configured to electrically couple (e.g., connect) adjacent bare cells 110 and the protection element 120 (e.g., the protection device) to each other, and a protective circuit module 140 positioned above the one surface 116 of the bare cells 110. A plurality of openings 143 (e.g., a plurality of holes) may be formed in the protective circuit module 140 (see FIG. 5).

The bare cells 110 are devices in which electrochemical energy is generated by the movement of ions and/or electrons.

The bare cells 110 may each be manufactured by accommodating an electrode assembly and an electrolyte in a battery case. Here, the electrode assembly is formed by winding or stacking a positive electrode plate and a negative electrode plate with a separator between the positive and negative electrode plates. The electrode assembly generates energy through an electrochemical reaction between the electrode assembly and the electrolyte, and the generated energy is supplied to outside of each of the bare cells 110 through, for example, an electrode terminal. For example, the battery case may be a pouch, prismatic/rectangular, or cylindrical shape battery case. An electrode terminal 113 (see FIG. 3) may be formed to protrude on or above the one surface 116 of each of the bare cells 110. The electrode terminal 113 may be electrically coupled to (e.g., electrically connected to) the protection element 120, to be further described later, through the connecting tab 130.

Meanwhile, the bare cells 110 of this embodiment may be a plurality of bare cells (e.g., two bare cells). In this case, the plurality of bare cells 110 may be positioned so that wide and flat surfaces from among side surfaces adjacent to the surfaces 116 of each of the bare cells 110 are opposite to each other. The plurality of bare cells 110 may be coupled (e.g., connected) in parallel or series. In this embodiment, the case where two bare cells 111 and 112 (i.e., a first bare cell 111 and a second bare cell 112) of the plurality of bare cells 110 are coupled in (e.g., connected in) parallel with each other will be described as an example.

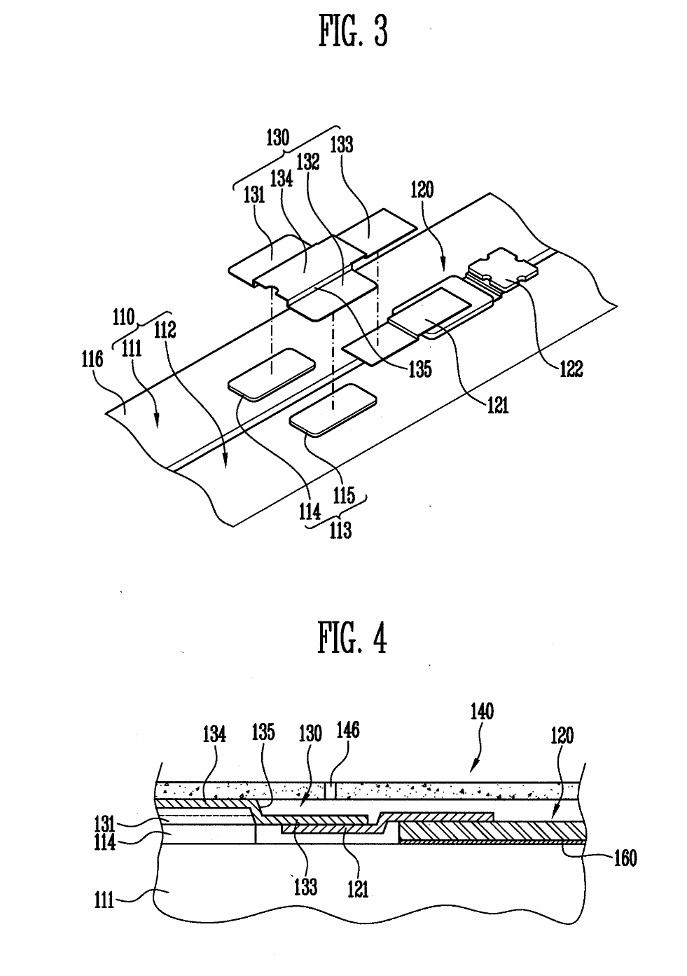

FIG. 2 is a perspective view of the battery pack 100a shown in FIG. 1 in which the protective circuit module 140 is not illustrated. FIG. 3 is an exploded perspective view of the battery pack 100a shown in FIG. 1 in which the protective circuit module 140 is not illustrated. Hereinafter, the protection element 120 (e.g., the protection device) according to this embodiment will be described in detail with reference to FIGS. 2 and 3.

The protection element 120 is a member which is positioned on the one surface 116 of the bare cells 110 to sense a temperature of the battery pack 100a, and cuts off a flow of current when its resistance increases (e.g., increases to a predetermined value) due to a temperature increase of the bare cells 110. Here, the protection element 120 is a member in which resistance varies or changes depending on temperature. For example, a positive temperature coefficient (PTC) element may be used in the protection element 120. When the temperature of the bare cells 110 or the battery pack 100a increases, the protection element 120 senses the increase in temperature (e.g., the protection element 120 also increases in temperature), and the resistance of the protection element 120 increases. When the heat generated by the bare cells 110 or the battery pack 100a exceeds a reference temperature (e.g., a predetermined temperature), the current input to or output from the protection element 120 may be cut off or stopped at first and second lead portions 121 and 122 of the protection element 120.

Meanwhile, the protection element 120 may not be provided to each of the plurality of bare cells 110. For example, one protection element 120 may be used for or provided to two bare cells 110 as shown in FIG. 3. Thus, it is possible to reduce component cost compared with a comparative example in which a protection element is coupled to (e.g., connected to) each of the plurality of bare cells. Further, it is possible to efficiently use space in the battery pack 100a including the plurality of bare cells 110. That is, the case where one protection element 120 is disposed on the two bare cells 111 and 112 uses less space than that used when two protection elements are disposed on the respective two bare cells 111 and 112, and hence it is possible to improve the compactness and decrease the weight of the battery pack 100a.

Meanwhile, the first lead portion 121 of the protection element 120 may be electrically coupled to (e.g., electrically connected to) a plurality of bare cells 110 through the connecting tab 130, to be further described later, and the second lead portion 122 of the protection element 120 may be electrically coupled to (e.g., electrically connected to) the protective circuit module 140 through, for example, soldering (see FIG. 1).

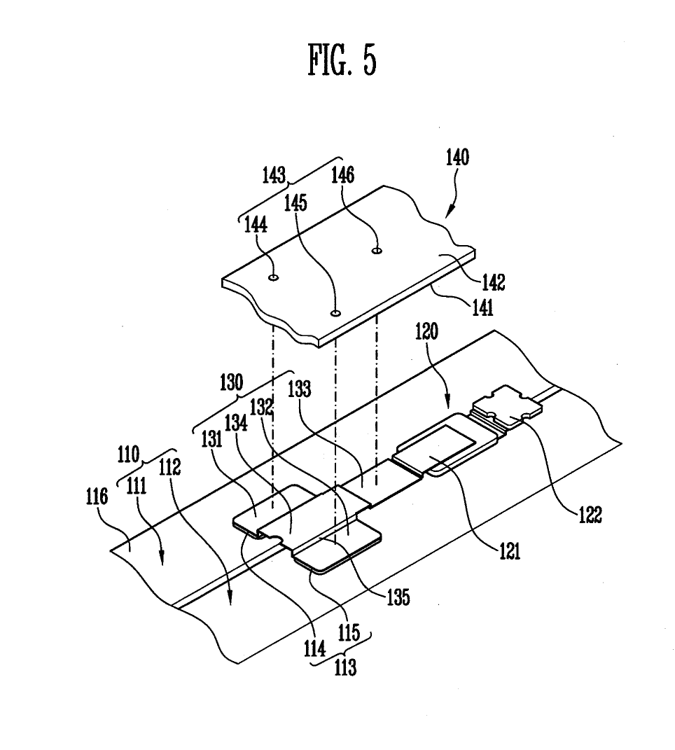

FIG. 4 is a sectional view taken along the line A-A′ of the battery pack 100a shown in FIG. 1. Hereinafter, the connecting tab 130 according to this embodiment will be described in detail with reference to FIGS. 2 to 4.

The connecting tab 130 is a member which electrically couples (e.g., electrically connects) a plurality of bare cells 110 to the protection element 120 (e.g., couples plurality of adjacent bare cells 110 to the protection element 120). Here, the connecting tab 130 may electrically couple (e.g., electrically connect), for example, one protection element 120 and the two bare cells 111 and 112 of the plurality of bare cells 110 adjacent thereto, i.e., the connecting tab 130 may couple at least three members to each other. For example, the connecting tab 130 may electrically couple (e.g., electrically connect) the first lead portion 121 of the protection element 120 and the electrode terminals 113 of the two bare cells 111 and 112. In this case, the connecting tab 130 may include a first connecting portion 131 coupled to (e.g., electrically connected to) a first electrode terminal 114 of the first bare cell 111 of the plurality of bare cells 110, a second connecting portion 132 coupled to (e.g., electrically connected to) a second electrode terminal 115 of the second bare cell 112, and a third connecting portion 133 electrically coupled to (e.g., electrically connected to) the first lead portion 121 of the protection element 120. That is, the connecting tab 130 may have a shape extending along three directions. Here, the first, second, and third connecting portions 131, 132, and 133 may be integrally connected (e.g., the first, second, and third connecting portions 131, 132, and 133 may be formed from a single piece), and accordingly, the electrode terminals 113 of the two bare cells 111 and 112 and the protection element 120 may be electrically coupled (e.g., electrically connected) through the connecting tab 130. Although it has been described in this embodiment that the number of connecting portions is three, one protection element 120 may be coupled to (e.g., connected to) three or more bare cells 110 by increasing the number of connecting portions according to the number of bare cells 110. That is, when the number of bare cells 110 is N and the number of connecting portions is N+1, a plurality of bare cells 110 may be electrically coupled to (e.g., electrically connected to) one protection element 120 (e.g., a single protection element or device) through the connecting tab 130.

Through the connecting tab 130 with the structure described above, one protection element 120 may be electrically coupled to (e.g., electrically connected to) a plurality of bare cells 110. Accordingly, it is unnecessary to use the protection element 120 for each bare cell 110 (that is, the number of protection elements 120 may be less than the number of bare cells 110), so that it is possible to reduce component cost caused by additional protection elements 120 and to improve the compactness and reduce the weight of the battery pack 100a. In addition, the electrode terminals 113 of the plurality of bare cells 110 are electrically coupled to (e.g., electrically connected to) one another through the connecting tab 130, and accordingly, it is possible to implement the parallel connection of the plurality of bare cells 110 through the connecting tab 130 without any separate or additional connecting member. Thus, it is possible to reduce cost due to the elimination of a component and to improve the compactness and reduce the weight of the battery pack 100a.

A main body portion 134 may be at (e.g., connected at) a position (e.g., a point) where the connecting portions 131, 132, and 133 meet one another. In this case, the connecting portions 131, 132, and 133 may extend from the main body portion 134. In order to implement the electrical connection between the bare cells 110 and the protection element 120, the connecting tab 130 may be made of a material having excellent electrical conductivity, for example, an electrically conductive metal, such as gold, silver, copper, or nickel.

Meanwhile, the connecting tab 130, the electrode terminals 113 of the bare cells 110, and the first lead portion 121 of the protection element 120 may be formed to overlap with one another. For example, the first connecting portion 131 may be positioned to overlap with a top surface of the first electrode terminal 114 of the first bare cell 111 (e.g., the first connecting portion 131 may be between the first electrode terminal 114 and the protective circuit module 140). The second connecting portion 132 may be positioned to overlap with a top surface of the second electrode terminal 115 of the second bare cell 112. The third connecting portion 133 may be positioned to overlap with a top surface of the first lead portion 121 of the protection element 120. On the whole, the connecting tab 130 may be overlapped with the electrode terminals 113 of the bare cells 110 (i.e., the first and second electrode terminals 114 and 155) and the first lead portion 121 so as to be positioned higher than the electrode terminals 113 of the bare cells 110 and the first lead portion 121 (that is, the connecting tab 130 may be above the electrode terminals 113 and the first lead portion 121). Accordingly, the connecting tab 130 is exposed (e.g., entirely exposed), and the electrode terminals 113 of the bare cells 110 and the first lead portion 121 of the protection element 120 may have portions exposed or may have no portion exposed. In this case, the connection among the connecting tab 130, the electrode terminals 113, and the first lead portions 121 may be performed through, for example, welding. Further, an insulating member 160 may be located between the protection element 120 and the surface 116 of the bare cells 110.

FIG. 5 is an exploded perspective view of the battery pack 100a shown in FIG. 1. Hereinafter, the protective circuit module 140 of the battery pack 100a according to this embodiment will be described with reference to FIGS. 1 to 5.

The protective circuit module 140 is a member which is positioned above the surfaces 116 of the bare cells 110 on which the connecting tab 130 and the protection element 120 are positioned and controls voltage or current flow during the charging and discharging of the bare cells 110. The protective circuit module 140 may be implemented with a circuit board on which a circuit pattern is formed, and several electronic components may be mounted on at least one surface of the protective circuit module 140. Here, the electronic components may be a field effect transistor (FET), an integrated circuit (IC), and/or the like. The electronic components may perform a function of controlling the electrode assemblies in the bare cells 110 or cutting off or stopping a circuit when the electrode assemblies are abnormally operated. The circuit board of the protective circuit module 140 may include a switching circuit to more efficiently control or protect, together with the electronic components, the battery pack 100a. For example, the protective circuit module 140 may prevent overcharging, overdischarging, overcurrent, short circuit, and/or reverse voltage of the battery pack 100a, so that it is possible to prevent an explosion, overheating, leakage, and/or prevent charging/discharging characteristics from being deteriorated. Further, the protective circuit module 140 may prevent a reduction in electrical performance and abnormal operation, so that it is possible to improve safety of and to extend the lifespan of the battery pack 100a.

Meanwhile, the protective circuit module 140 may have a first surface 141 and a second surface 142 opposite to the first surface 141. Here, the first surface 141 of the protective circuit module 140 is opposite to the bare cells 110 (e.g., the first surface 141 faces the bare cells 110), and the second surface 142 of the protective circuit module 140 may be exposed to the outside of the battery pack 100a (e.g., the second surface 142 faces away from the bare cells 110). The second lead portion 122 of the protection element 120 may be electrically coupled to (e.g., electrically connected to) the first surface 141, and a pad coupled to (e.g., connected to) an external wire or the like (e.g., an external load) may be provided on the second surface 142. In this case, the protection element 120 and the connecting tab 130 may be positioned between the first surface 141 of the protective circuit module 140 and the bare cells 110. Accordingly, the protection element 120, the connecting tab 130, and the electrode terminals 113 of the bare cells 110 may not be exposed when being viewed from the top of the battery pack 100a.

Meanwhile, the plurality of openings 143 penetrating from the first surface 141 to the second surface 142 may be formed in the protective circuit module 140 (e.g., the plurality of openings 143 may extend through the protective circuit module 140). In this case, the openings 143 may be formed to respectively correspond to the position at which the connecting tab 130 and the protection element 120 are coupled (e.g., connected) and the position at which the connecting tab 130 and the bare cells 110 are coupled (e.g., connected). For example, three of the plurality of openings 143, including first, second, and third openings 144, 145, and 146 (e.g., first, second, and third holes), may be respectively formed at areas of the protective circuit module 140 to correspond to the position at which the first connecting portion 131 of the connecting tab 130 is coupled to (e.g., connected to) the first electrode terminal 114 of the first bare cell 111, the position at which the second connecting portion 132 of the connecting tab 130 is coupled to (e.g., connected to) the second electrode terminal 115 of the second bare cell 112, and the position at which the third connecting portion 133 of the connecting tab 130 is coupled to (e.g., connected to) the first lead portion 121 of the protection element 120.

Therefore, in a case where the first connecting portion 131 is coupled to (e.g., connected to) and overlaps the first electrode terminal 114, the second connecting portion 132 is coupled to (e.g., connected to) and overlaps the second electrode terminal 115, and the third connecting portion 133 is coupled to (e.g., connected to) and overlaps the first lead portion 121, the first, second, and third connecting portions 131, 132, and 133, relatively positioned higher than (e.g., positioned above) the first electrode terminal 114, the second electrode terminal 115, and the first lead portion 121, may be exposed through the respective first, second, and third openings 144, 145, and 146. In this case, the openings 143 function to allow or facilitate (e.g., to implement) the connections between the connecting tab 130, the bare cells 110, and the protection element 120. Equipment, such as welding rods, are inserted into or through the respective openings 143 so that the first connecting portion 131 and the first electrode terminal 114 may be welded to each other, the second connecting portion 132 and the second electrode terminal 115 may be welded to each other, and the third connecting portion 133 and the first lead portion 121 may be welded to each other.

Meanwhile, in a case where the protective circuit module 140 and the connecting tab 130 are not coupled to each other but are separated from each other (e.g., spaced apart from each other), a noise or undesired short circuit may occur. In order to solve such a problem, it may be considered that the protective circuit module 140 and the connecting tab 130 be manufactured as one module (e.g., as a single module) by being previously coupled to each other. In this case, the protective circuit module 140 covers the connecting tab 130, and hence, it may be difficult to electrically couple (e.g., electrically connect) the connecting tab 130 to the bare cells 110 and the protection element 120. That is, it may be very difficult to weld the connecting tab 130 to the bare cells 110 and the protection element 120 by inserting a welding rod into a narrow space between the protective circuit module 140 and the bare cells 110 when the battery pack 110a is manufactured. However, in the battery pack 100a according to this embodiment, the plurality of openings 143 for the connection of the connecting tab 130 are provided in the protective circuit module 140, and hence, it can be relatively easy to weld the connecting tab 130 to the bare cells 110 and the protection element 120 by inserting the welding rod into the openings 143. That is, in the battery pack 100a according to this embodiment, the protective circuit module 140 and the connecting tab 130 are previously coupled to each other, so that it is possible to solve a problem caused by the spacing between the protective circuit module 140 and the connecting tab 130 and to provide convenience during the process of coupling (e.g., connecting) the connecting tab 130 to the bare cells 110 and the protection element 120.

In a case where the protective circuit module 140 and the connecting tab 130 are coupled as one module, the protective circuit module 140 and the connecting tab 130 may be physically coupled through, for example, an adhesive or solder. A portion (e.g., a point) of the connecting tab 130 that is coupled to the protective circuit module 140 may become the main body portion 134 which does not directly contact the bare cell 110 and/or the protection element 120, but the present invention is not limited thereto.

Meanwhile, in a case where the connecting tab 130 is implemented in a planar structure (e.g., in a case where the connecting tab 130 is planar), because the adhesive or solder between the main body portion 134 and the protective circuit module 140 is formed very thin, and even though the area actually coupled to the protective circuit module 140 is the main body portion 134, the connecting portions 131, 132, and 133 may contact the protective circuit module 140 or may be positioned very close to the protective circuit module 140. In this case, the space between the connecting tab 130 and the protective circuit module 140 may be relatively small. Because various electronic components and circuit patterns are formed on the protective circuit module 140, an undesired or unintentional short circuit may occur.

In order to solve such a problem, as shown in FIGS. 1 to 5, the connecting tab 130 of the battery pack 100a according to this embodiment may have a shape in which the main body portion 134 is protruded. That is, in the connecting tab 130, a distance from the protective circuit module 140 to the main body portion 134 may be different from a distance from the protective circuit module 140 to the first, second, or third connecting portion 131, 132, or 133. When the protruded main body portion 134 is coupled to the protective circuit module 140, the connecting portions 131, 132, and 133 may be relatively further from the protective circuit module 140 than the main body portion 134. That is, a first distance from the protective circuit module 140 to the first, second, or third connecting portion 131, 132, or 133 may be different from a second distance from the protective circuit module 140 to the main body portion 134. The first distance may be greater than the second distance. Thus, the area in contact with the protective circuit module 140 is only the main body portion 134, and accordingly, it is possible to efficiently use the limited space in the protective circuit module 140 and to improve the electrical safety of the battery pack 100a.

The specific configuration of the connecting portion 130 may be implemented by forming a step 135 (e.g., a step difference) between at least one of the main body portion 134 and the first connecting portion 131, the main body portion 134 and the second connecting portion 132, and the main body 134 and the third connecting portion 133. However, the present invention is not limited to the step 135. For example, a configuration in which a portion of the connecting portion 130 is protruded, such as an inclination surface (e.g., an inclined or angled surface), may be variously implemented.

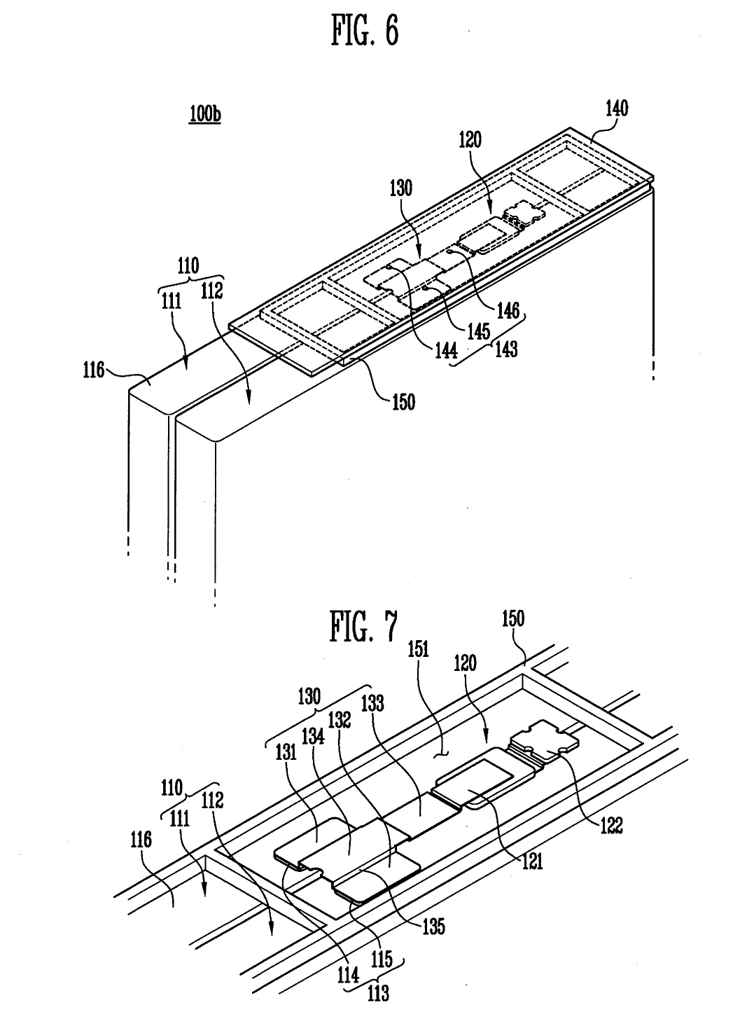

FIG. 6 is a perspective view of a battery pack 100b according to another embodiment of the present invention. FIG. 7 is a perspective view of the battery pack 100b shown in FIG. 6 in which a protective circuit module 140 is not illustrated. Here, substantially similar or identical components corresponding to those of the aforementioned embodiment are designated by like reference numerals, and their detailed descriptions may be omitted to avoid redundancy.

The battery pack 100b according to this embodiment includes the plurality of bare cells 110, the protection element 120, the connecting tab 130 configured to electrically couple (e.g., electrically connect) the bare cells 110 and the protection element 120, and the protective circuit module 140 having the plurality of openings 143 (e.g., a plurality of holes). The battery pack 100b may further include a holder 150.

The holder 150 is positioned on one surface 116 of the bare cells 110, the same surface on which the connecting tab 130 and the protection element 120 are positioned. The protective circuit module 140 may be positioned on the holder 150. That is, the holder 150 is between (e.g., interposed between) the bare cells 110 and the protective circuit module 140. In this case, the holder 150 may perform a function of setting the position of the protective circuit module 140 (e.g., the position of the protective circuit module 140 may be set or determined by the holder 150). At least one opening 151 may be provided in or inside the holder 150, and the protection element 120 and the connecting tab 130 may be positioned in the opening 151. Thus, the protection element 120 and the connecting tab 130 are not exposed to the outside due to the holder 150 and the protective circuit module 140, and accordingly, it is possible to improve the electrical safety of the battery pack 100b.

Meanwhile, the protective circuit module 140 is positioned on the holder 150, and hence, the height relationship further described below may be set such that the holder 150 and the connecting tab 130 having the protruding-shaped main body portion 134 coupled to the protective circuit module 140 are on substantially the same plane. For example, a height of the holder 150 (e.g., a height of the holder 150 above the surface 116 of the bare cells 110) may be substantially equal to the sum of a height (e.g., a thickness) of the electrode terminals 113, a thickness of the first connecting portion 131, the distance between the first connecting portion 131 and the main body portion 134, and a thickness of the main body portion 134, and accordingly, a top surface of the holder 150 and the main body portion 134 may be on substantially the same plane. Thus, the protective circuit module 140 may be coupled to (e.g., connected to) the electrode terminals 113 without any deformation of the connecting tab 130 caused by a difference in height and may be stably positioned in the holder 150.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims and their equivalents.

What is claimed is:

1. A battery pack comprising:
a plurality of bare cells;
a protection device on the plurality of bare cells;
a connecting tab configured to electrically couple the bare cells to the protection device; and
a protective circuit module positioned on the bare cells,
wherein the protective circuit module has a plurality of openings at positions where the connecting tab is coupled with the bare cells and/or the protection device.

2. The battery pack of claim 1, wherein the connecting tab comprises:
a first connecting portion coupled to a first bare cell from among the bare cells;
a second connecting portion coupled to a second bare cell from among the bare cells; and
a third connecting portion coupled to the protection device.

3. The battery pack of claim 2, wherein the plurality of openings comprises:
a first opening at an area of the protective circuit module, corresponding to the position at which the first connecting portion and the first bare cell are coupled; and
a second opening at an area of the protective circuit module, corresponding to the position at which the second connecting portion and the second bare cell are coupled.

4. The battery pack of claim 3, wherein the plurality of openings further comprises
a third opening at an area of the protective circuit module, corresponding to the position at which the third connecting portion and the protection device are coupled.

5. The battery pack of claim 2, wherein the first connecting portion is electrically coupled to a first electrode terminal of the first bare cell,
wherein the second connecting portion is electrically coupled to a second electrode terminal of the second bare cell, and
wherein the third connecting portion is electrically coupled to a first lead portion of a plurality of lead portions of the protection device.

6. The battery pack of claim 5, wherein the first connecting portion overlaps with a top surface of the first electrode terminal,
wherein the second connecting portion overlaps with a top surface of the second electrode terminal, and
wherein the third connecting portion overlaps with a top surface of the first lead portion.

7. The battery pack of claim 6, wherein the openings are respectively located in the protective circuit module at positions corresponding to the first, second and third connecting portions.

8. The battery pack of claim 5, wherein a second lead portion of the plurality of lead portions of the protection device is electrically coupled to the protective circuit module.

9. The battery pack of claim 2, wherein the connecting tab further comprises a main body portion coupled to the first, second and third connecting portions, and
wherein the first, second and third connecting portions are extended from the main body portion.

10. The battery pack of claim 9, wherein a first distance from the protective circuit module to the first, second, or third connecting portion is different from a second distance from the protective circuit module to the main body portion.

11. The battery pack of claim 10, wherein the first distance is greater than the second distance.

12. The battery pack of claim 9, wherein the connecting tab further comprises a step between at least one of the main body portion and the first connecting portion, the main body portion and the second connecting portion, or the main body portion and the third connecting portion.

13. The battery pack of claim 9, wherein the main body portion and the protective circuit module are coupled to each other.

14. The battery pack of claim 13, wherein the main body portion and the protective circuit module are coupled to each other through soldering.

15. The battery pack of claim 1, wherein the coupling between the connecting tab and the bare cells, and/or the coupling between the connecting tab and the protection device are performed through the openings.

16. The battery pack of claim 15, wherein the coupling between the connecting tab and the bare cells, and/or the coupling between the connecting tab and the protection device are performed through the openings, using welding.

17. The battery pack of claim 1, further comprising a holder positioned between the protective circuit module and the plurality of bare cells.

18. The battery pack of claim 17, wherein the protection device and the connecting tab are positioned inside an opening in the holder.

19. The battery pack of claim 1, wherein the plurality of bare cells are coupled in parallel to each other.

20. The battery pack of claim 1, further comprising an insulating member between the protection device and the plurality of bare cells.
